(19) United States
(12) Patent Application Publication
(10) Pub. No.: US 2026/0010912 A1
(43) Pub. Date: Jan. 8, 2026

(54) AUTOMATED GENERATION SYSTEMS AND METHODS OF REGULATORY COMPLIANCE DATA PACKAGES HAVING ACCESS CONTROL

(71) Applicant: JPMorgan Chase Bank, N.A., New York, NY (US)

(72) Inventors: Frank Derbin, Jersey City, NJ (US); Nathan Edmonds, Newcastle, WA (US); Ture Armas, Seattle, WA (US)

(73) Assignee: JPMorgan Chase Bank, N.A., New York, NY (US)

(21) Appl. No.: 18/762,156

(22) Filed: Jul. 2, 2024

(51) Int. Cl. G06Q 30/018; G06Q 10/0637

(52) U.S. Cl. CPC G06Q 30/018; G06Q 10/06375

(57) ABSTRACT

Aspects of the subject disclosure may include, for example, collecting a plurality of source data having a scope defined by a target regulatory requirement, transforming the plurality of source data to derive decoded responses by applying a set of automated logics that implements a compliance to the target regulatory requirement, converting the decoded responses into machine-readable encoded data required for the target regulatory requirement, and proceeding to encoded data submission to be published to a content administrator and downstream systems of the automated regulatory compliance data package generation system. Other embodiments are disclosed.

The subject disclosure relates to systems and methods facilitating and implementing automated generation of regulatory compliance data packages having access control.

### BACKGROUND

Financial institutions are frequently subject to regulatory requirements which involve collection and disclosure of certain information. Violation or noncompliance to the regulatory requirements may result in a monetary penalty or potential disruption to business operations. The regulatory requirements can require extensive and complex set of information and compliance to the regulatory requirements can be strictly enforced. For instance, Dodd Frank Wall Street Reform and Consumer Protection Act (“Dodd Frank”) governs a collection of small business lending data. Dodd Frank 1071 amended Equal Credit Opportunity Act (ECOA) to require financial institutions to compile, maintain, and submit certain data on applications for women-owned, minority-owned and small businesses to the Consumer Financial Protection Bureau (CFPB). The final ruling on Dodd Frank Section 1071 was made by the CFPB on Mar. 30, 2023, and requires that lenders originating more than 2,500 small business loans annually must collect data required for compliance reporting beginning on Oct. 1, 2024.

Under the Dodd Frank 1071, there are eighty-one unique data points that must be reported, each containing an accompanying set of complex logic that details a correct value to be reported given the disposition and terms of a loan, client disclosure, and/or nature of a small business applying for the loan. Compliance to the Dodd Frank 1017, through an extensive manual process, is prone to an inconsistent application of regulatory procedures. Repeated non-compliance would result in audit findings, sanctions, and restrictions levied by the Office of the Comptroller of the Currency (OCC) on financial institutions' ability to provide small business loans.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of an enterprise automated compliance system in accordance with various aspects described herein.

FIG. 2 schematically illustrates automated compliance operations in accordance with various aspects described herein.

FIG. 3 depicts an illustrative embodiment of an event-listener model in accordance with various aspects described herein.

FIG. 4 depicts an illustrative embodiment of a method in accordance with various aspects described herein.

FIG. 5 depicts an illustrative embodiment of another method in accordance with various aspects described herein.

FIG. 6 depicts an illustrative embodiment of a user interface in accordance with various aspects described herein.

FIG. 7 depicts an illustrative embodiment of another form of a user interface in accordance with various aspects described herein.

FIG. 8 depicts an illustrative embodiment of further another method in accordance with various aspects described herein.

FIG. 9 depicts an illustrative embodiment of yet further another method in accordance with various aspects described herein.

FIG. 10 depicts an illustrative embodiment of an additional method in accordance with various aspects described herein.

### DETAILED DESCRIPTION

The subject disclosure describes, among other things, illustrative embodiments for systems and methods facilitating and implementing automated generation of regulatory compliance data packages having access control. Upon receiving and determining source data in scope, the systems and methods automatically generate a data package that contains a set of data/information. In the generated data package, a sequence of decoding, transformation, and encoding processes is performed by utilizing an event-listener model or executing an event-listener program. For instance, a change to one or more items of the source data will be considered as an event, which will trigger the sequence of decoding, transformation, and encoding processes, thereby facilitating automated, near real time, and/or asynchronous processing. Other embodiments are described in the subject disclosure.

One or more aspects of the subject disclosure include a device including a processing system of an automated regulatory compliance data package generation system including a processor; and a memory that stores executable instructions that, when executed by the processing system, facilitate performance of operations. The operations include collecting a plurality of source data having a scope defined by a target regulatory requirement; transforming the plurality of source data to derive decoded responses by applying a set of automated logics that implements a compliance to the target regulatory requirement; converting the decoded responses into machine-readable encoded data required for the target regulatory requirement; and proceeding to encoded data submission to be published to a content administrator and downstream systems of the automated regulatory compliance data package generation system.

One or more aspects of the subject disclosure include a non-transitory machine-readable medium, comprising executable instructions that, when executed by a processing system of an automated generation system of regulatory compliance data package including a processor, facilitate performance of operations. The operations include detecting an event based on a change to one or more source data relevant to a target regulatory requirement, wherein the one or more source data include different categories of data; in response to the detected event, transforming the one or more source data to derive decoded responses by applying a set of automated logics that implements a compliance to the target regulatory requirement; converting the decoded responses into encoded values; submitting the one or more source data, the decoded responses, and the encoded values to a first user system; and generating a package containing the one or more source data, the decoded responses, and the encoded values and sharing the package with a second user system.

One or more aspects of the subject disclosure include a method include collecting, by a processing system an automated regulatory compliance data package generation system including a processor, source data; determining that the collected source data are in scope which is defined by a target regulatory requirement; upon the determination of in scope, automatically generating, by the processing system, a data package including the collected source data; for the generated data package, executing, by the processing system, an event-listener program by: in response to detecting an event, transforming, by the processing system, the collected in scope source data to derive decoded responses by applying a set of automated logics that implements a compliance to the target regulatory requirement; converting, by the processing system, the decoded responses into machine-readable encoded data required for the target regulatory requirement; and submitting, by the processing system, the data package including the collected in scope source data, the decoded responses, and the machine-readable encoded data, to be published to a content administrator and downstream systems of the automated regulatory compliance data package generation system.

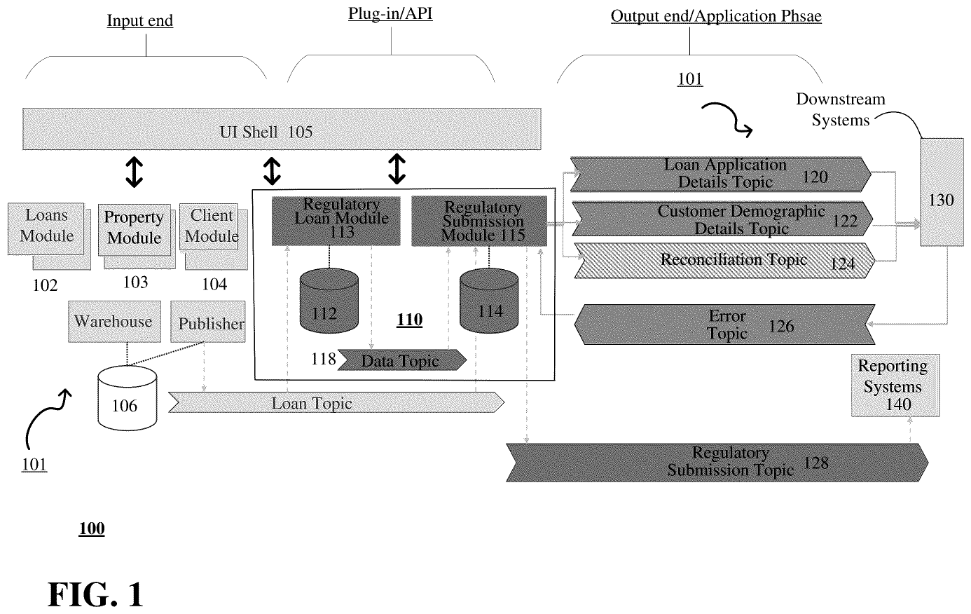

FIG. 1 is a block diagram illustrating an exemplary, non-limiting embodiment of an enterprise automated compliance system 100 in accordance with various aspects described herein. The enterprise automated compliance system 100 (“the system 100”) describe embodiments involving loans and directed to the Dodd Frank 1071, for convenience of description and by way of example only. Compliance to requirements under the Dodd Frank 1071 require eighty-one unique data points that must be reported, and each data point contains an accompanying set of complex logic that details a correct value to be reported given the disposition and terms of a loan, client disclosure, and/or nature of a small business applying for the loan. The system 100 is configured to perform data capture, transformation and reporting such that compliance is to be automated and an extensive manual process prone to an inconsistent application of regulatory procedures can be avoided. The present disclosure is not limited to the Dodd Frank 1071 application and can be used with various other regulatory compliance requirements by utilizing various other source data.

In various embodiments, the system 100 is configured to collect and receive source data, determine whether the source data is relevant to or in scope of a target regulatory requirement, and upon the determination of relevance or being in scope, and automatically generate a data package that contains a set of data/information. The system 100 may utilize a series of configurable set of pattern matching algorithms to determine if source data changes are relevant or not to either becoming in-scope/out of scope or generating/updating data packages. In the generated data package, a sequence of decoding, transformation, and encoding processes is performed by utilizing an event-listener model or executing an event-listener program. For instance, a change to one or more items of the source data will be considered as an event, which will trigger the sequence of decoding, transformation, and encoding processes, thereby facilitating automated, near real time, and/or asynchronous processings.

In various embodiments, the sequence of decoding, transformation, and the encoding processes may be performed based on a specific set of rules and logics that are determined and designed for compliance with the target regulatory requirement. By way of example only, the specific set of rules and logics can include coded expressions, coded subroutines, coded sequences, coded flows, or a combination thereof that implement the compliance with the target regulatory requirement. From system users' or end users' perspective, providing or adding source data into the system 100 may result in a comprehensive data package that may ensure the compliance with the target regulatory requirement via an automated process, thereby facilitating and enabling transparent and automated processing to system users or end users. The system 100 may be configured and/or coded to receive, analyze, and process the source data by utilizing a flexible, dynamically changeable set of rules and automatically generate the data package that will comply with the target regulatory requirement. The generated data package will be readily transformed into a necessary reporting product or other required forms to comply with the target regulatory requirement. Over time a new regulatory requirement is introduced and the system 100 may still be able to receive, analyze, and process the source data by utilizing a new set of rules corresponding to the new regulatory requirement. To the extent that the source data overlaps or relevant to the new regulatory requirement, the same set of data/information contained in the generated data package can be used. If additional information or data are needed, a new set of data, which will likely be a much less amount than requiring an entirely new universe of source data, can be added or requested as source data, which facilitate efficient and fast collection and processing of the source data.

In various embodiments, a regulatory compliance requirement module, can be implemented as a program module, an application program interface (API), a plug-in software program, etc. in order to implement the target regulatory requirement or a new regulatory requirement. The regulatory compliance requirement module can be included in, loosely coupled to, or be coordinated with the system 100. The regulatory compliance requirement module can provide specific functions, specific processing, and specific implementation customized to the target regulatory requirement or the new regulatory requirement and a rest of the system 100 performs their native and/or original functions and processing. The rest of system 100 utilizes specific and customized data, functions, processing, information, etc. which are available from the regulatory compliance requirement module, which will in turn utilize certain aspects, data/information, processing capabilities, etc. of the rest of system 100. In that way, the system 100 can accommodate ever changing regulatory requirements without starting over every time that new requirements are rolled out, avoid or minimize massive data collection, processing and storage, and maximize efficiency and flexibility of operations.

In various embodiments, different and various access control and/or document access control can be applied to data and information relevant to the target regulatory requirement or the new regulatory requirement, depending on a content and a nature of such regulatory requirements.

In various embodiments, the generated data package will be submitted for a quality control purpose. Additionally, the generated data package will also be submitted to downstream systems of a particular enterprise as needed. The generated data package may be modified or adjusted based on error feedback from the downstream systems. The data package may be used later for different regulatory requirement purposes, to the extent that the set of data/information contained in the data package are in scope or relevant to the different regulatory requirement purposes.

In various embodiments, the system 100 includes an enterprise platform 101, a user interface 105, and a regulatory compliance automation module 110. In certain embodiments, the enterprise platform 101 may correspond to an enterprise legacy system which include an existing computing hardware and software system in use. In certain embodiments, the enterprise platform 101 may include a general computing system which performs various tasks needed for a particular enterprise. In other embodiments, the enterprise platform 101 may include a transition computing system which accommodates different phases of enterprise tasks. The user interface 105 is communicatively coupled to the current enterprise platform 101 and the regulatory compliance automation module 110 (“the module 110”). The user interface 105 can be implemented with various technologies that are available and is not limited to a particular form or manner.

In various embodiments, the enterprise platform 101 performs tasks and processes data for a financial institution. The enterprise platform 101 includes a loans module 102, a property module 103, and a client module 104 by way of example only. The loans module 102 and the property module 103 capture, process and transform data content relating to loans, assets, etc. The client module 104 communicates with clients, users, subscribers, customers, etc. of an enterprise such as a financial institution in order to perform tasks required for that institution. Additionally, the client module 104 may enable clients to provide or update documents needed or required by a financial institution. By way of example only, the enterprise platform 101 may collect and capture source data including and not limited to regulatory requirements such as address information, business information, guarantees, principal owners, application details, credit product, etc. These items are associated with source field name, pages, attributes, logic, etc.

In various embodiments, the enterprise platform 101 includes a data store 106 in communication with the loans module 102, the property module 103, and the client module 104 and stores enterprise data in accordance with enterprise data management policies and relevant regulations. A publisher provides, transmits or broadcast the stored data and information to different applications, modules, downstream systems, etc. within the enterprise, such that different applications, modules, systems, and downstream systems execute and perform necessary tasks, as shown with an arrow labeled “Loan Topic.” Additionally, the publisher follows enterprise security policies to allow particular users, personnel, applications, departments, task teams, etc. to access or not access specific set of information, data, documents, etc. In some embodiments, the publisher includes and executes predetermined logics to analyze and check before submitting data and information to a part of an enterprise or an entire enterprise.

In various embodiments, the loans module 102, the property module 103, and the client module 104 along with the publisher serve as an input end for the system 100. As depicted in FIG. 1, the enterprise platform 101 contains downstream systems 130 and the reporting system 140 which serve as an output end and/or an application end for the system 100. In various embodiments, the downstream systems 130 include data warehouses used for reporting, compliance systems that correlate data, additional systems that perform quality checks. The downstream systems may not be limited to a particular system and any system that may be interested in transformed information for post processing is considered as the downstream systems.

In various embodiments, the module 110 is also communicatively, logically, and/or functionally coupled to the enterprise platform 101. In various embodiments, the module 110 can be added to the enterprise platform 101, removed from the enterprise platform 101, and/or modified or configurable or customizable based on a need by the enterprise platform 101. The module 110 can be present, formed and implemented, independently of the enterprise platform 101. The module 110 can communicate with the enterprise platform 101 or exchange data, regardless of and without processing data formats of the enterprise platform 101.

In various embodiments, the module 110 is implemented with, operates or is placed as a plug-in software program. The plug-in software program may facilitate flexible addition, removal, and/or modification based on different needs. Like the Dodd Frank 1071 example, regulatory compliance requirements may be subject to change, new requirements are being introduced, existing regulatory requirements may be updated or modified, and an occurrence of changes generally tends to be more frequent.

In various embodiments, the module 110 may be encapsulated from the enterprise platform 101 as the encapsulation presents a consistent interface that is independent of internal implementation. For instance, the encapsulation may facilitate hiding values or states of a structured data object inside a class and blocking direct access to hidden implementation details or state invariance that should be maintained in the system 100. Additionally, or alternatively, encapsulation may facilitate resistance and resilience to potential security threats as security compromises may be contained or limited to a part of the system 100 rather than the entirety of the system 100.

In various embodiments, the module 110 may be implemented as a REST API (Representational State Transfer Application Programming Interface). The REST API implementation provides a flexible way to integrate the module 110 with the system 100 and connect the module 110 with a rest of the system 100. An API operates as a mechanism that enables the module 110 to access a resource within applications or services provided in the system 100. In the REST API implementation, the module 110 operates as a server and the applications or services provided in the system 100 operate as a client. In other situations, the module 110 operates as a client and the applications or services provided in the system 100 can operate as a server. The roles of the client and the server may change depending on whether the module 110 contains a resource, or accesses resources contained in another application or service. The REST API implementation can be functional and flexible as REST APIs are flexible with a programming language and support a variety of data formats.

In various embodiments, the module 110 includes a regulatory load module 113 and a regular submission module 115. As depicted in FIG. 1, the regulatory load module 113 is communicatively coupled to a database 112 which stores relevant data from the regulatory load module 113. The regulatory submission module 115 is also communicatively coupled to another database 114 which stores necessary data from the regulatory submission module 115.

In various embodiments, the loan module 102, the property module 103, the client module 104, the UI shell 105 and a data store 106 are configured as data capture UI/services/persistence in a transactional information system that feeds the regulatory loan module 110, the database 112, the regulatory submission module 115, the database 114 and the data topic 118. The UI shell 105 is owned by the transactional information system; however, the regulatory loan and submission modules 113 and 115 may own separate UI components that are hosted within the same shell.

In various embodiments, the regulatory submission module 115 is configured to implement a specific schema that determines how data is organized within a database. By way of example, the specific schema defines field names including Application ID, Source Type, Source Data, Line of Business, Loan Number, Dodd Frank 1071 Action taken or any other regulatory requirement action taken, Action Date, Application Recipient, Applicant Desired Loan Amount, Denial Reasons, etc. Based on each field name, the specific schema further defines Section including “Create Submission,” “Denial Reasons,” “Credit Product,” etc. Values corresponding to the field names are obtained and stored. As one example, the field name can have values of in person, telephone, online, mail, etc. and the Denial Reasons field name can have values of cashflow, collateral, time in business, aggregate exposure, unverifiable information, etc. The specific schema implemented in the module 115 represent a logical view of the entire database. It describes the shape of the data and how it relates to other models, tables and databases, and devises all the constraints applied to that data.

In addition, data captured and collected from the regulatory load module 113 is provided to the regulatory submission module 115 as shown with Data Topic arrow 118 in FIG. 1, which will be further described in detail below.

In various embodiments, the enterprise platform 101 further includes the downstream systems 130 and the reporting system 140 which receive data or information from the input end of the enterprise platform 101, the module 110, or both, as depicted in FIG. 1. Based on operations and functional demands from the downstream systems 130, different set of data or information are provided such as loan application detail topic 120, customer demographic detail topic 122, reconciliation topic 124, etc. For instance, the reconciliation topic 124 acts as an out-of-band notification of what has been published on the main data topics (topic 120 and 122). The reconciliation topic 124 is used by the downstream systems 130 to confirm that the downstream systems 130 positively have received (can reconcile) all data events on 120 and 122, and can automatically detect problems related to either publication or event consumption on the main topics.

In various embodiments, the downstream systems 130 can provide error information as error topic 126 to the module 110. The downstream systems 130 analyze and review the data or the information provided thereto and provide feedback such as whether the provided data or information may not comply with regulatory requirements such as the requirements under the Dodd Frank 1071. It is possible that transformation succeeds in code, however the downstream system 130 provides further information/errors. In this example, the transformed dataset is shared downstream with a central Quality Control (QC) system for the enterprise, such as that system may reject a portion of the data due to data quality issues that are identified further downstream or due to a business rule (e.g. submission received too late, post cutoff) or due to system errors (e.g. partial data received due to system crash). Such rejection may be fed back to the regulatory submission module 115 as the error topic 126. In addition, as the Dodd Frank 1017 requires specific reporting, the module 110 provides relevant information to the reporting systems 140.

The module 110 provides regulatory submission topic 128 to the reporting systems 140. In various embodiments, data is presented in a slightly different ways/topics for management reporting teams/systems and downstream QC systems. The approach for both consumers is the same, but the data format is different hence separate topics for the same data (e.g. QC systems require highly normalized format, while reporting systems require a highly denormalized format).

Other regulatory requirements which require reporting can be implemented in the reporting systems 140. The reporting systems receive corresponding topics from other relevant modules (not shown) based on regulatory requirements.

In various embodiments, the module 110 executes the following sequence of operations: source data collection, source data transformation, encoded data translation, sharing encoded data submissions, security policies for data access, and hybrid security policies for documents access. The source data collection operations involves collection of loan terms, intended use of funds, small business information, and principal business owner demographics. This information is captured during loan origination through traditional paper forms, digitally enabled forms via DocuSign, and verbal confirmation. By way of example only, in connection with Dodd Frank 1071 loans, there are over 150 data points required at this stage.

The source data transformation operations involve aggregating and evaluating source data captured during loan origination and applying a set of automated rules to derive appropriate “decoded” responses to a large number of questions (e.g., close to a hundred questions) required for compliance reporting. By way of example, the Dodd Frank 1071 involves eighty-one questions. For instance, decoded values are human-readable answers to each of the eighty-one questions. Transformation rules are complex, involving multiple logic branches, as well as contingent rules from other decoded answers. Specifically, the disposition and terms of the loan, client disclosure, and/or nature of the small business applying for the loan are used in combination to derive decoded answers. The underlying architecture is asynchronous in nature and follows an event-listener pattern, with multiple modules publishing and subscribing to data changes in near-real-time fashion.

In various embodiments, the decoded answers are subject to a converting process or encoding process. The converting or the encoded process involves encoded data translation which converts the decoded answers into machine-readable “encoded” values required for regulatory reporting. By way of example only, encoded values may include integers that are prescribed for each of the eighty-one questions required for compliance reporting in the context of the Dodd Frank 1017. Different regulatory requirements can be addressed with different numbers, letters, values, etc. that are encoded for compliance reporting.

In various embodiments, the sequence of sharing encoded data submissions operations follow. These operations encompass features for content administrators to review and compare the source, decoded, and encoded data, as well as programmatically package and share all this data with downstream systems 130. Accordingly, the architecture underlying the process is asynchronous in nature and has robust error handing, retry, and confirmation protocols.

In various embodiments, security policies for data access includes system entitlements to restrict data points from view, edit, creation, and calculation override transactions across multiple modules in the system. These entitlements are based upon user role (e.g., Role Based Access Security) and data presented (known as Access Control Lists). These entitlements are required to ensure multiple lines of business within commercial real estate have minimally required access to client and loan application data, as well as to ensure underwriters do not have access to information that may inject bias into a decision for an application for credit. Entitlements here are secured within the database of the system itself.

In various embodiments, hybrid security policies for documents access includes system entitlements to restrict digital documents collected during loan origination from download transactions. These entitlements are based upon user role (known as Role Based Access Security-RBAC). These entitlements are required to ensure underwriters do not have access to information that may inject bias into a decision for an application for credit. Entitlements here are secured within the database of the system itself and are also used when attempting to retrieve documents from downstream systems used for archival.

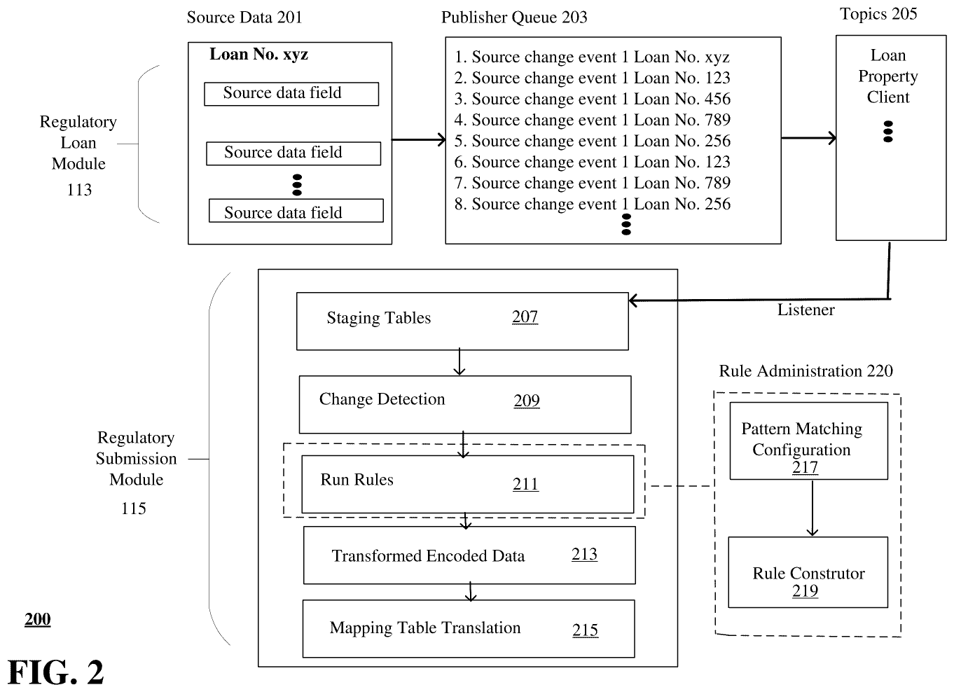

FIG. 2 schematically illustrates automated compliance operations 200 in accordance with various aspects described herein. The operations 200 includes operations at the regulatory loan module 113 and operations at the regulatory submission module 115 as depicted in FIG. 1. The regulatory loan module 113 captures source data from the input end of the enterprise platform 101, via the user interface 105, or both. The captured source data are processed as events and entered onto a publisher queue 203. Individual changes promote near real time feedback and scale as compared to traditional batch based processing. The batch-driven processing may be suited for scenarios where real-time processing is not critical such that large batches of data can be processed efficiently. To the contrary, event-driven processing may be best suited for scenarios where real-time processing is critical. Data can be processed as soon as it arrives.

In various embodiments, typical batch based event to listen processes run on a schedule (e.g. hourly, every few hours or nightly as an example). As this is a publish and subscribe architecture, it allows for subscribers to be instantly notified when source data events are published, so data processing can occur “near-real time” which would typically mean, by way of example only, within seconds or less of a source data publisher publishing the data. The feedback element would mean that data transformation and the quality check process would immediately show the source data changes through the user interface which would allow for much easier and efficient testing as well as monitoring of the entire process, as more traditional approaches may require an extended period of time, such as a few hours or overnight, to see the source data changes flow through the system (e.g., the system 100 in FIG. 1).

The source change data event queued in the publisher queue 203 is passed to Topics 205. Topics 205 facilitate a more granular control for a publisher to determine which events to fire when there are data changes at the source data. There are separate topics, which are defined as queued events (as shown 203) plus a data schema that defines the structure of that event/message. By way of example only, exemplary benefit is that when loan data changes, only a new loan message is broadcast on the Loan topic, as opposed to broadcasting messages on related Property and Client topics as well. By contrast, if Topics 205 were that data is represented on a single topic, it would result in a large message encompassing Loan, Property, and Client data even if no change about Property or Client actually has occurred or has been made.

Referring back to FIG. 1, in various embodiments, the regulatory submission module 115 as shown in FIG. 1 is configured to operate as a listener of events. In other words, the events based on changes to source data trigger operations by the regulatory submission module 115. The operations at the regulatory submission module 115 includes generating staging tables where source data are staged as highly normalized name/value pairs (207). This may correspond to the source data transformation operations involving aggregating and evaluating source data captured during loan origination. Using change detection patterns, change(s) from the staging tables and manual data entry are detected (209). In some embodiments, manual data entry may be overridden.

In various embodiments, a set of automated rules is applied to derive appropriate “decoded” responses to a large number of questions (e.g., close to a hundred questions) required for compliance reporting (211). By way of example, the Dodd Frank 1071 involves eighty-one questions. For instance, decoded values are human-readable answers to each of the eighty-one questions. Transformation rules are complex, involving multiple logic branches, as well as contingent rules from other decoded answers. By way of example only, the disposition and terms of the loan, client disclosure, and/or nature of the small business applying for the loan are used in combination to derive decoded answers. The underlying architecture is asynchronous in nature and follows an event-listener pattern, with multiple modules publishing and subscribing to data changes in near-real-time fashion.

In various embodiments, by way of example only, source values include CML, MFL, in person, online, originated, withdrawn, incomplete, directly/indirectly, business start-up, purchase, excessive credit obligations, n/a, etc. By way of example only, decoded field names include Application Method, Line of Business, Application Recipient, Credit Purpose, Denial Reasons, Variable Rate Index Name, etc. By way of example only, encoded field codes can be integer numbers, such as 1, 2, 3, 4, 10, 11, 977, 988, 32, 33, 36, 37, etc. These examples are solely for the purpose of description and the present disclosure is not limited thereto. In various embodiments, source value, source field, decoded field name, decoded field value, and/or encoded field code can form transformation lookup tables and can be organized and stored in the manner that data/information/content relevant to each item of source value, source field, decoded field name, decoded field value, and/or encoded field code. Accordingly, the transformation lookup tables are configured to translate encoded data into translated formats and data can be stored as highly normalized name/value pairs.

In various embodiments, the rules are managed by using a rule administration module 220. The rule administration module 220 includes a pattern matching configuration module 217 and a rule constructor module 219. The pattern matching configuration module 217 stores generic formulas and variables to support regulatory requirements and/or line of business specific pattern matching to construct rules on the fly (217). By way of example only, these would be input criteria into the rule, e.g., IF “Line of business=‘Multifamily Lending’ AND “loan status=‘Funded’.” The rule constructor module 219 is configured to dynamically construct rules syntax into coded rules using a pattern matching configuration. Encoded data translation by obtaining data, managing rules used in translation, and making the translation more data driven, instead of hard coding every rule, facilitates flexible and dynamic construction of rules on the fly.

In various embodiments, the rule administration module 220 can be configured to add, modify or update relevant rules based on the need for various different regulatory requirements. The relevant rules can be dynamically constructed into the rules syntax which correspond to the coded rules using the pattern matching configuration.

In various embodiments, the decoded answers are subject to a converting or encoding process (213). The converting or the encoded process involves encoded data translation which converts the decoded answers into machine-readable “encoded” values required for regulatory reporting. By way of example only, encoded values may include integers that are prescribed for each of the eighty-one questions required for compliance reporting in the context of the Dodd Frank 1017. Different regulatory requirements can be addressed with different numbers, letters, values, etc. that are encoded for compliance reporting. The transformed data are staged as highly normalized name/value pairs. Encoded data are transformed into translated format and data are stored as highly normalized name/value pairs (215).

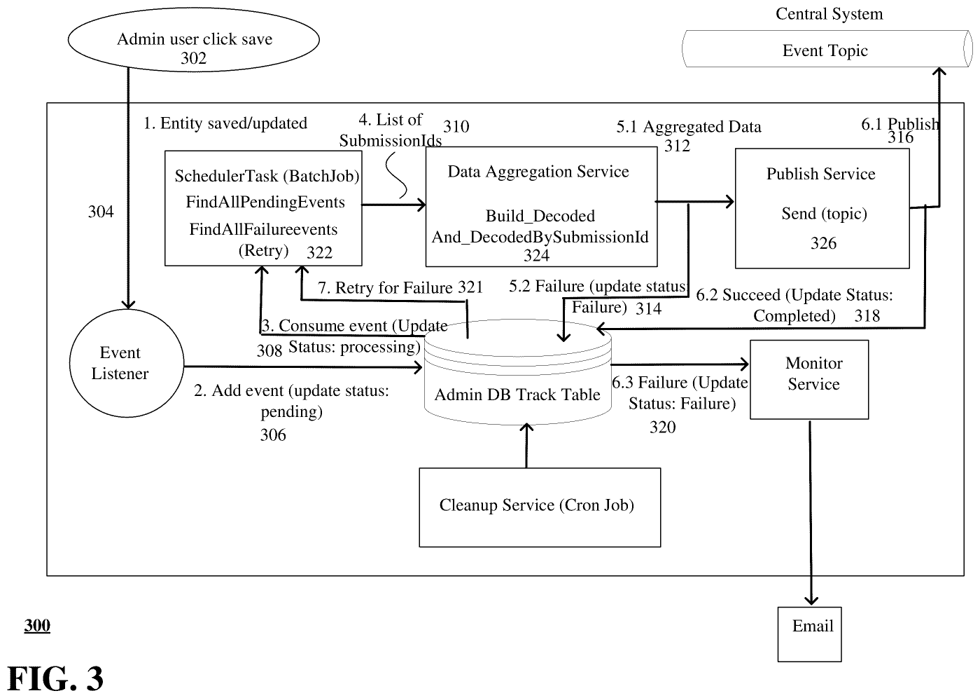

FIG. 3 depicts an illustrative embodiment of an event-listener model 300 in accordance with various aspects described herein. In various embodiments, the event-listener model 300 operates such that a user saves and updates a submission related entity (302). An event listener adds an event payload to track table (304) and update an event status to “Pending” (306). A schedulerTask process 322 picks up “Pending” events at intervals which are configurable. A Data AggregationService process 324 aggregates data provided from the SchedulerTask process to build a particular data event in a machine readable format (312). If building data has no issue, a Publish Service process (326) is called to publish data (316). If building data has filed, the event status is updated to “Failure” (314) and it becomes ready to retry (322). If publishing succeeds, it updates status to “Complete.” If failed, the event status is updated to “Failure and it is again ready to retry (320, 321). Cleanup service will clean up completed or stale event at specified intervals. A monitor service monitors failure or error and email notifications.

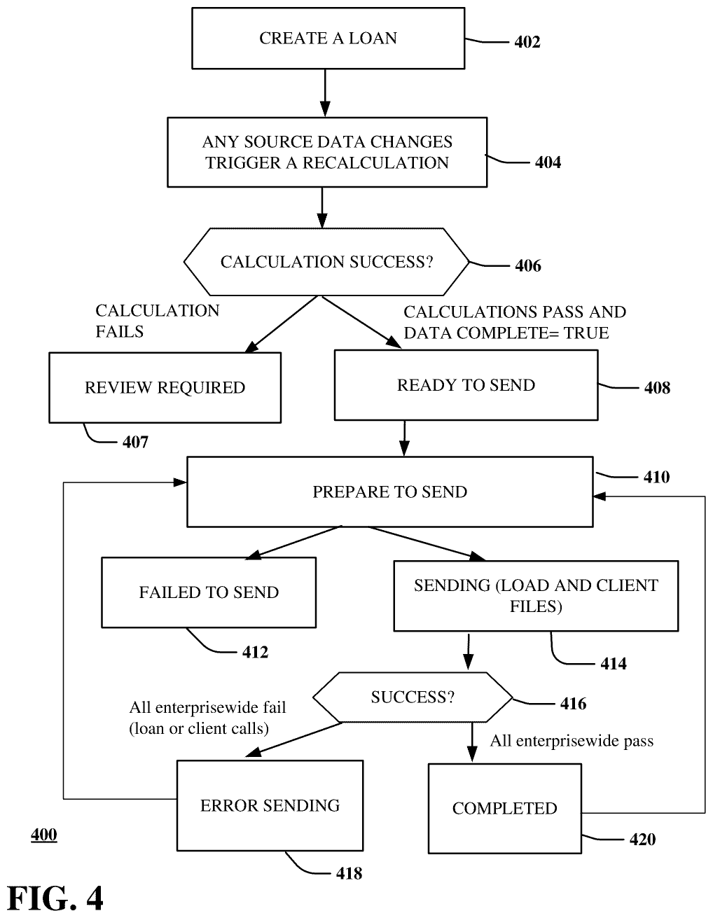

FIG. 4 depicts an illustrative embodiment of a method 400 in accordance with various aspects described herein. In various embodiments, the method 400 includes creating a loan (204) by a user using an enterprise platform. A loan publisher consumes warehouse data and loan data is published on a loan topic of the enterprise platform. A regulatory compliance loan module and a regulatory compliance administrative module subscribe to loans topics and consume data relating to loan, client, property data, etc. The loan information is submitted for initial underwriting and it is check that some information is valid to comply with regulatory requirements. Using DF1071 examples, it is checked whether an entity income is less than five million dollars by way of example. Whenever source loan data is changed, the regulatory submission module evaluates if a loan is in scope or not. Upon determination that the loan is in scope, updates are published on the enterprise platform. These updates are consumed by the enterprise platform and the regulatory requirement modules. A submission is created for a loan in the regulatory submission module.

In various embodiments, scoping rules are important to the process and the data package that is ultimately transmitted to the regulator (the regulator should only get data packages for loan application that were determined “In Scope”). A constant process of monitoring source data changes to determine if a loan application either becomes in scope, or falls out of scope is extremely relevant, as the data package would need to be updated accordingly. If a loan was previously in scope, and is now determined to no longer be in scope due to a source attribute change, then the submission would need to be marked as “Not in Scope” and potentially transmitted downstream to further systems to take that submission out of scope for regulatory filing.

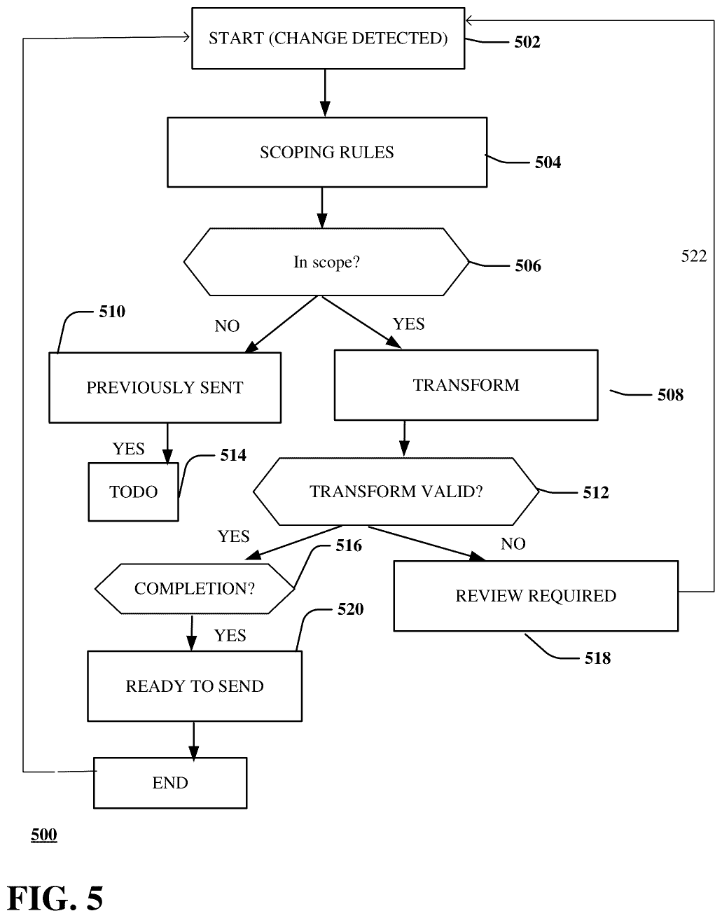

FIG. 5 depicts an illustrative embodiment of a method 500 in accordance with various aspects described herein. In various embodiments, the method 500 includes starting a process when changes to source data are detected (502). It is determined whether the changes to source data are in scope of rules or not (504). As described above, scoping rules are important to the process and the data package that is ultimately transmitted to the regulator should include data packages for loan application that were determined “In Scope.” Upon the determination of in scope (506), the changes are transformed (508). Upon the determination of not being in scope (506), it is determine whether such changes to source data are previously sent (510) and added to a to-do list upon determination that the previously sent is correct (514). Subsequent to transform (508), it is checked whether the transformation is valid or not (512). The valid transformation proceeds to a completion check (516) which in turn leads to “Ready to send” (520). Tasks relating to the changes to source data are ended. If the transformation is not valid (512), a review is required (518) and a next action (522) goes back to the starting point (502).

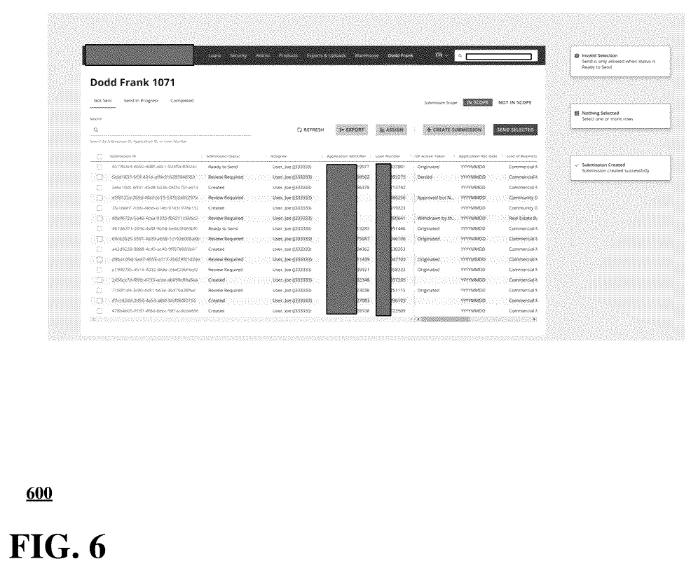

FIG. 6 depicts an illustrative embodiment of a user interface 600 implementing a regulatory compliance application in accordance with various aspects described herein. By way of example only, the user interface 600 prompts various menus and options for users to view and perform necessary tasks. As described above in connection with FIGS. 3-5, the user interface 600 shows each status of information packages listed based on submission ID, for example, “Ready to send,” “Created,” “Review Required,” etc. Each information package listed based on submission ID is also associated with various other fields of information, such as Assignee, Application Identifier, Dodd Frank Action taken, Line of Business, etc.

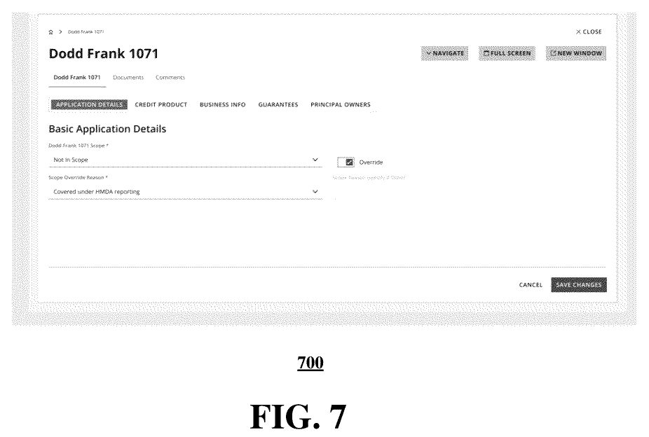

FIG. 7 depicts an illustrative embodiment of another user interface 700 implementing another regulatory compliance application in accordance with various aspects described herein. By way of example only, the user interface 700 prompts, to users, customers, reviewers, quality check personnel, etc., various processes that guide and allow users et al. to provide relevant information required for Dodd Frank 1071 in order to automate the process of collecting, decoding, transforming, and submitting a complete set of information package, eventually for preparing a complete reporting package that complies the extensive regulatory requirements.

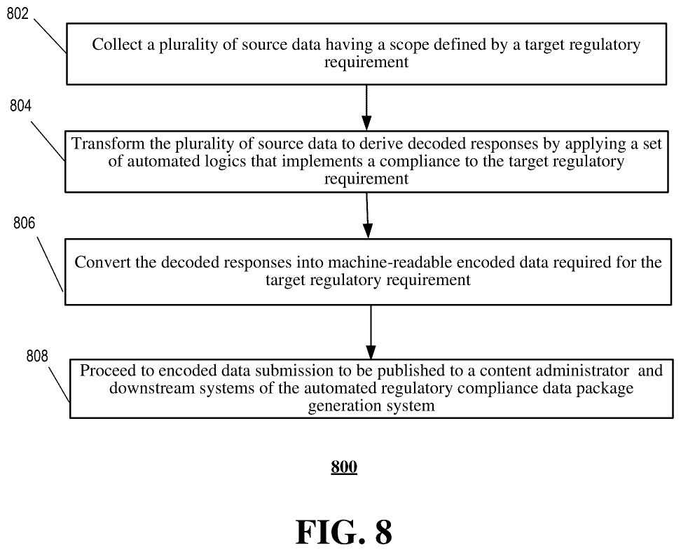

FIG. 8 depicts an illustrative embodiment of a method in accordance with various aspects described herein. In various embodiments, the method 800 includes collecting a plurality of source data having a scope defined by a target regulatory requirement (Step 802), transforming the plurality of source data to derive decoded responses by applying a set of automated logics that implements a compliance to the target regulatory requirement (Step 804), converting the decoded responses into machine-readable encoded data required for the target regulatory requirement (Step 806), and proceeding to encoded data submission to be published to a content administrator and downstream systems of the automated regulatory compliance data package generation system (Step 808).

In various embodiments, the method 800 further includes detecting an event based on a change to one or more source data of the plurality of source data. The method 800 also includes, in response to the detected event, triggering the transformation of the changed one or more source data to derive the decoded responses. The detecting of the event, the triggering of the transformation, the transforming, and the converting, take place in near real-time fashion. Additionally, or alternatively, the detecting of the event, the triggering the transformation, the transforming, and the converting, take place asynchronously.

In various embodiments, the decoded responses comprise human-readable answers and the encoded data comprise machine-readable values. The encoded data comprise different integers corresponding to the target regulatory requirement.

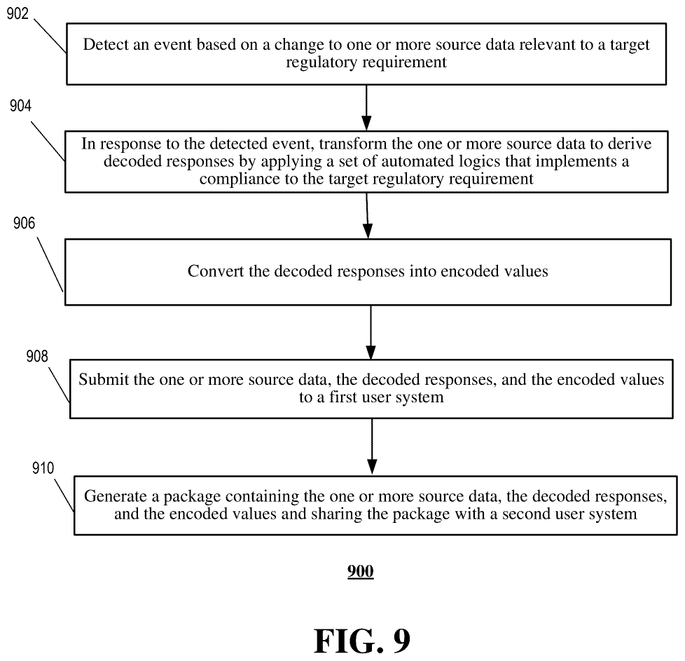

FIG. 9 depicts an illustrative embodiment of another method in accordance with various aspects described herein. In various embodiments, the method 900 includes detecting an event based on a change to one or more source data relevant to a target regulatory requirement (Step 902), in response to the detected event, transforming the one or more source data to derive decoded responses by applying a set of automated logics that implements a compliance to the target regulatory requirement (Step 904), converting the decoded responses into encoded values (Step 906), submitting the one or more source data, the decoded responses, and the machine-readable encoded values to a first user system (Step 908), and generating a package containing the one or more source data, the decoded responses, and the machine-readable encoded values and sharing the package with a second user system (Step 910). The detecting the event further includes detecting the change from the staged source data.

In various embodiments, the method 900 includes constructing coded rules based on rule syntaxes using a pattern matching configuration and based on a plurality of variables associated with the target regulatory requirement. The method 900 further includes staging source data as normalized name and value pairs.

In various embodiments, the package generation (Step 910) is actually automated as a part of determining that the source data is relevant to the target regulatory requirement. Source data transformation is grouped together in the package. Users also perform a cursory review within the boundary of the package, which is specific to that point-in-time. Once completed, the package is sent downstream (user triggers the action but the feed is automated thereafter). Over time additional packages could be created using the same data depending on the nature of the same or different regulatory requirement(s).

In various embodiments, the method 900 further comprise executing an event-listener model by: in response to the detected event directed to a source data of a first category, triggering transformation of the source data of the first category, and triggering no transformation of the one or more source data of a rest of the different categories having no change. The method 900 further comprise determining that the one or more source data is relevant to the target regulatory requirement, and upon the determination, automating the generation of the package. The method 900 further comprise: enabling the first user system to review content of the generated package, wherein the review by the first user system is specific to a particular point in time, and enabling the first user system to trigger an action that submits the generated package to the second user system. The method 900 further comprise generating a new package using the content of the generated package, wherein the new package includes a modification relevant to a new target regulatory requirement.

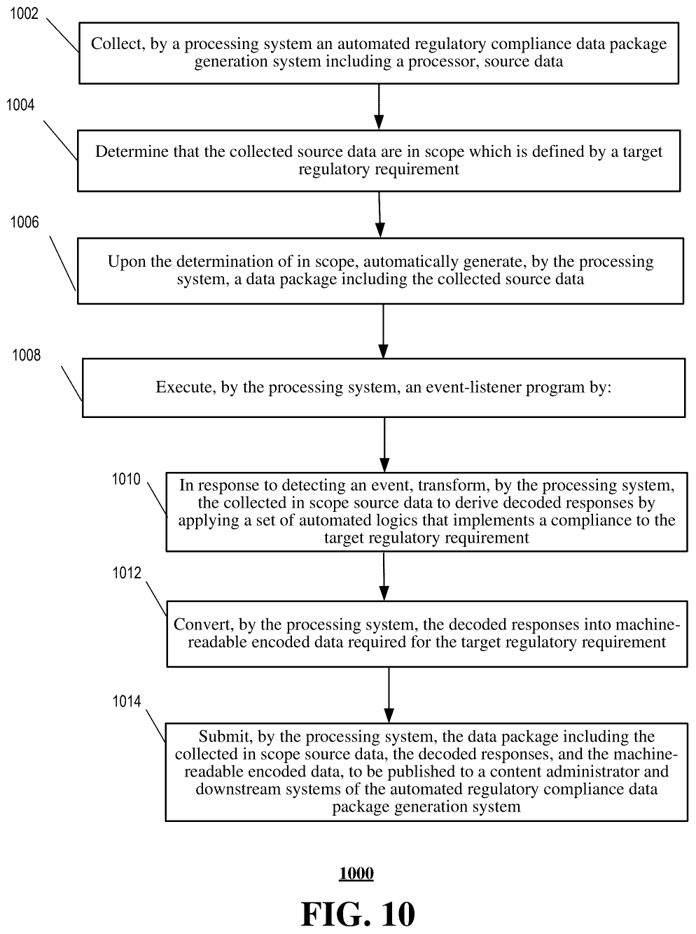

FIG. 10 depicts an illustrative embodiment of further another method in accordance with various aspects described herein. In various embodiments, the method 1000 includes collecting, by a processing system, an automated regulatory compliance data package generation system including a processor, source data (Step 1002), determining that the collected source data are in scope which is defined by a target regulatory requirement (Step 1004), upon the determination of in scope, automatically generating, by the processing system, a data package including the collected source data (Step 1006), for the generated data package, executing, by the processing system, an event-listener program (Step 1008) by: in response to detecting an event, transforming, by the processing system, the in scope source data to derive decoded responses by applying a set of automated logics that implements a compliance to the target regulatory requirement (Step 1010), converting, by the processing system, the decoded responses into machine-readable encoded data required for the target regulatory requirement (Step 1012), and submitting, by the processing system, the data package including the collected source data, the decoded responses, and the machine-readable encoded data, to be published to a content administrator and downstream systems of the automated regulatory compliance data package generation system (Step 1014).

In various embodiments, the executing the event-listener program (Step 1008) further comprises: detecting, by the processing system, the event based on a change to one or more source data among the collected in scope source data; and in response to the detected event, triggering, by the processing system, an action responding to the detected event. The method 1000 further comprises receiving, by the processing system, an error topic from the downstream systems, wherein the error topic includes at least a portion of rejected data based on data quality, a business rule, a system error, or a combination thereof. In the method 1000, the decoded responses comprise human-readable answers and the machine readable encoded data comprise different integers corresponding to the target regulatory requirement. The method 1000 includes enabling, by the processing system, the content administrator to review content of the generated package, wherein the review by the content administrator is specific to a particular point in time; and enabling, by the processing system, the content administrator to trigger an action that submits the generated package to the downstream systems. The method 1000 includes generating, by the processing system, a new package using the content of the generated package, wherein the new package includes a modification relevant to a new target regulatory requirement.

While for purposes of simplicity of explanation, the respective processes are shown and described as a series of blocks in FIGS. 8 through 10, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system of an automated regulatory compliance data package generation system including a processor; and
a memory that stores executable instructions that, when executed by the processing system, facilitate performance of operations, the operations comprising:
collecting a plurality of source data having a scope defined by a target regulatory requirement;
transforming the plurality of source data to derive decoded responses by applying a set of automated logics that implements a compliance to the target regulatory requirement;
converting the decoded responses into machine-readable encoded data required for the target regulatory requirement; and
proceeding to encoded data submission to be published to a content administrator and downstream systems of the automated regulatory compliance data package generation system.

2. The device of claim 1, wherein the operations further comprise detecting an event based on a change to one or more source data of the plurality of source data.

3. The device of claim 2, wherein the operations further comprises, in response to the detected event, triggering the transformation of the changed one or more source data to derive the decoded responses.

4. The device of claim 3, wherein the detecting of the event, the triggering of the transformation, the transforming, and the converting, take place in near real-time fashion.

5. The device of claim 3, wherein the detecting of the event, the triggering of the transformation, the transforming, and the converting, take place asynchronously.

6. The device of claim 1, wherein the decoded responses comprise human-readable answers and the encoded data comprise machine-readable values.

7. The device of claim 1, wherein the machine-readable encoded data comprise different integers corresponding to the target regulatory requirement.

8. A non-transitory machine-readable medium, comprising executable instructions that, when executed by a processing system of an automated generation system of regulatory compliance data package including a processor, facilitate performance of operations, the operations comprising:
detecting an event based on a change to one or more source data relevant to a target regulatory requirement, wherein the one or more source data include different categories of data;
in response to the detected event, transforming the one or more source data to derive decoded responses by applying a set of automated logics that implements a compliance to the target regulatory requirement;
converting the decoded responses into encoded values;
submitting the one or more source data, the decoded responses, and the encoded values to a first user system; and
generating a package containing the one or more source data, the decoded responses, and the encoded values and sharing the package with a second user system.

9. The non-transitory machine-readable medium of claim 8, wherein the operations further comprise constructing coded rules based on rule syntaxes using a pattern matching configuration and based on a plurality of variables associated with the target regulatory requirement.

10. The non-transitory machine-readable medium of claim 9, wherein the operations further comprise staging the one or more source data as normalized name and value pairs, and
the detecting the event further comprises detecting the change from the staged one or more source data.

11. The non-transitory machine-readable medium of claim 8, wherein the operations further comprise executing an event-listener model by:
in response to the detected event directed to source data of a first category, triggering transformation of the source data of the first category; and
triggering no transformation of the one or more source data of a rest of the different categories having no change.

12. The non-transitory machine-readable medium of claim 8, wherein the operations further comprise:
determining that the one or more source data is relevant to the target regulatory requirement; and
upon the determination, automating the generation of the package.

13. The non-transitory machine-readable medium of claim 12, wherein the operations further comprise:
enabling the first user system to review content of the generated package, wherein the review by the first user system is specific to a particular point in time; and
enabling the first user system to trigger an action that submits the generated package to the second user system.

14. The non-transitory machine-readable medium of claim 13, wherein the operations further comprise generating a new package using the content of the generated package, wherein the new package includes a modification relevant to a new target regulatory requirement.

15. A method, comprising:
collecting, by a processing system an automated regulatory compliance data package generation system including a processor, source data;
determining that the collected source data are in scope which is defined by a target regulatory requirement;
upon the determination of in scope, automatically generating, by the processing system, a data package including the collected source data;
for the generated data package, executing, by the processing system, an event-listener program by:
in response to detecting an event, transforming, by the processing system, the collected in scope source data to derive decoded responses by applying a set of automated logics that implements a compliance to the target regulatory requirement;
converting, by the processing system, the decoded responses into machine-readable encoded data required for the target regulatory requirement; and
submitting, by the processing system, the data package including the collected in scope source data, the decoded responses, and the machine-readable encoded data, to be published to a content administrator and downstream systems of the automated regulatory compliance data package generation system.

16. The method of claim 15, wherein the executing the event-listener program further comprises:
detecting, by the processing system, the event based on a change to one or more source data among the collected in scope source data; and
in response to the detected event, triggering, by the processing system, an action responding to the detected event.

17. The method of claim 16, further comprising receiving, by the processing system, an error topic from the downstream systems, wherein the error topic includes at least a portion of rejected data based on data quality, a business rule, a system error, or a combination thereof.

18. The method of claim 15, wherein the decoded responses comprise human-readable answers and the machine-readable encoded data comprise different integers corresponding to the target regulatory requirement.

19. The method of claim 15, further comprising:
enabling, by the processing system, the content administrator to review content of the generated data package, wherein the review by the content administrator is specific to a particular point in time; and
enabling, by the processing system, the content administrator to trigger an action that submits the generated data package to the downstream systems.

20. The method of claim 19, further comprising:
generating, by the processing system, a new package using the content of the generated data package, wherein the new package includes a modification relevant to a new target regulatory requirement.
